(19) United States
(12) Patent Application Publication
(10) Pub. No.: US 2010/0323126 A1
(43) Pub. Date: Dec. 23, 2010

(54) Apparatus and Method for Plasma-Assisted Coating and Surface Treatment of Voluminous Parts

(75) Inventor: Stefan Laure, Stuttgart (DE)

Correspondence Address: BABCOCK IP, PLLC, P.O.BOX 488, BRIDGMAN, MI, 49106, US

(73) Assignee: Dr. Laure Plasmatechnologie GmnH, Stuttgart (DE)

(21) Appl. No.: 12/528,591

(22) PCT Filed: Feb. 26, 2008
(86) PCT No.: PCT/DE2008/000330

§ 371 Date: Aug. 25, 2009

(30) Foreign Application Priority Data
Feb. 26, 2007 (DE) 10 2007 009 581.5

(51) Int. Cl. H05H 1/42

(52) U.S. Cl. 427/575; 118/671

(57) ABSTRACT

Disclosed are an apparatus and a method for plasma-supported coating and surface treatment of voluminous parts. The apparatus features a vacuum chamber (3, 20, 32) comprising one or more pumps, a first resonant circuit with a first high frequency generator (5, 17, 28, 40), with an adjustable capacitance and an adjustable inductance of the first resonant circuit, and a first connection for integrating the part (1, 21, 32, 39) into the first resonant circuit, with at least a second resonant circuit with a second high frequency generator (18, 29, 40), with a second connector for integrating the part (1, 21, 32, 39) into the second resonant circuit and an adjustable capacitance and an adjustable inductance of the second resonant circuit. According to the disclosed method the inductance and/or the capacitance of the first and second resonant circuits are determined based on the part (1, 21, 31, 39).

### BACKGROUND

### State of the Art

The invention results from an apparatus and a method for plasma-supported coating and surface treatment of voluminous parts.

When the surface of part is exposed to plasma, the functionality and characteristics of the surface can be changed and controlled through the appropriate selection of plasma parameters such as pressure, temperature and composition. From the state of the art, methods are known for treatment, modification and coating a surface with any type of material, in which particle or energy fluxes from a plasma are used. This includes, among other things, plasma injections, arc plasma meltings, plasma heat treatment methods, CVD methods and plasma cleaning. The change of functionality of component surfaces results from the selective attack of plasma particles. This can occur through the mutual reaction with particles having definite chemical characteristics or by the application of radiation emitted by plasma. By the method of plasma coating of a part, the coating substance is changed by the addition of energy into a vaporous or gaseous condition, and isolated on the part from the vaporous or gaseous phase.

A plasma torch is used to produce a plasma, for example an arc plasma generator, a high frequency plasma generator or a microwave plasma generator.

The thermal plasmas described above are suitable for processing parts distinguished by a certain temperature elasticity. For parts made of synthetic material or parts already coated which can only be exposed to maximum temperatures of 100-200° C., such methods cannot be applied.

A plasma treatment with known plasma generators is indeed appropriate for small parts, but is not suitable for large parts. The plasma only occurs in a narrowly limited region and does not form over the entire part. The plasma treatment of the whole surface of a large part, the plasma jet has to be sent over the part. That is for parts such as vehicle bodies associated with high time and cost expenses.

High frequency generators are likewise used to produce thin plasmas with relatively small energy density. Its frequency range lies between a few hundred Khz and several 10 Ghz. The plasma is produced on the surfaces of electrodes or antennae in the form of a source and spreads out into the area. The coating substance is dissolved by sputtering from a so-called sputter target or steamed by the methods of physical vapor deposition, PVD for short, and eventually deposits on the part. One drawback is that the composition and temperature of the plasma changes as the distance from the plasma torch increases. In this way the separation of an equal layer is made more difficult on the entire surface of the part. Moreover only coatings of a limited number of materials can be produced by using this method.

A drawback to the plasma treatment of the entire surface of a large part with PVD methods consists in the fact that the central free range must be large and the pressure in the vacuum chamber very small. This is due to the size of the vacuum chamber linked with the size of the part being associated with high technical and financial costs.

Furthermore the known methods are not suitable for treating fissures, joints, cavities and undercuts, which occur in vehicle bodies. The surfaces facing away from the plasma source are not exposed to the same type of plasma. On surfaces facing toward the plasma source similar treatment cannot be guaranteed due to the strong gradient. This is true especially for treatment procedures dominated by radiation processes.

### THE INVENTION AND ITS ADVANTAGES

On the other hand the apparatus depicted by the invention with the characteristics of claim 1 and the method depicted by the invention with the characteristics of claim 7 have the advantage that large parts can be covered over their entire surface with a plasma treatment having similar effects, and that by means of a reaction of the substances contained in the plasma on the surface of the parts, a layer or system of layers can be deposited. By means of at least two resonant circuits with at least two high frequency generators each with adjustable inductance and capacitance, and by attaching or integrating the part into at least two resonant circuits, a plasma with adjustable and variable particle density and energy is produced on the surface and also in the cavities bordered by the part, as the case may be, The formation of the plasma depends on the components of the resonant circuit, especially on the excitation frequency, the capacitances of the resonant circuits and the part, and the inductances of the resonant circuits and the part. Thereby the inductance and capacitance of the part are preset. All other components and the related parameters are adjustable. The apparatus and the method are distinguished based on the many adjustable parameters due to a high flexibility and variability of the energy and particle density of the plasma to be produced on the surface of a part.

By means of at least another additional resonant circuit, an extra degree of freedom is gained to adjust the parameters of the plasma on the surface of the part. The excitation frequency of the first and second, as well as any other high frequency generators, as the case may be, can be identical or different. If all high frequency generators are being operated with the same excitation frequency, this results that, in comparison to only one high frequency generator, more performance is achieved in the plasma. If the excitation frequencies are varied and adjusted differently for each resonant circuit, the different excitation modi can be activated in the plasma. In this way specific particles such as atoms, electrons or ions in the plasma can be produced, chemical reactions in the plasma are enabled or supported, and the emission of radiation of a desired wave length can be generated.

The resonant circuits are unassociated with each other and can be operated independently from each other. Then too, each resonant circuit is furnished with its own high frequency generator and additional inductances and capacitances.

The apparatus can be operated as a multi-frequency plasma generator.

The treatment and coating includes both inner and outer surfaces. Fissures, joints, cavities and undercuts are likewise processed. Areas such as these occur especialy with parts which are composed of several elements.

The apparatus depicted by the invention and the method depicted by the invention can be applied with any parts of different sizes. They are especially suitable for large parts, for example vehicle bodies, aircraft and machine parts, to name just a few. A precondition for this is that the vacuum chamber must be of the requisite size, and the part can be inserted into the vacuum chamber and isolated from the vacuum chamber. In order to insert the part into the vacuum chamber and remove the part from the vacuum chamber, the vacuum chamber can be furnished with a transport mechanism.

The part is introduced into the vacuum chamber of the apparatus. It is preferable to use a transport mechanism for this purpose. Next the part is connected to the first resonant circuit with the first high frequency generator or coupled to the first resonant circuit at least partially without contact. For this purpose the part is galvanically, capacitively or inductively connected into the resonant circuit. There is also the possibility of using hybrids of the coupling. The part, for example, can be coupled to the resonant circuit galvanically on one pole and capacitatively on the other pole. An inductive coupling results, for example over a coil which is installed near the part in the vacuum chamber. The part thus forms a section of the first resonant circuit. Following this, or at the same time, the part is connected in the same way into the second resonant circuit. The high frequency alternating current of the first and second resonant circuit flows through the part. The inductance and the capacitance of the part thereby influence the inductance and capacitance of the resonant circuit. In order to assure the optimal coupling of the electrical power to the part, the two resonant circuits, each of which consists of the part to be operated and the additional capacitances and inductances, must be adapted accordingly. This occurs by the variation of capacitances and inductances of the resonant circuits. The calibration of the capacitances and inductances of the resonant circuits can be done either manually or automatically. When automatically tuned, first the capacitance and inductance of the part are determined. The variation of the capacitances and inductances of the resonant circuit brings about a change in the frequency of the resonant circuits.

Different treatments are possible for the part with the apparatus depicted by the invention and the method depicted by the invention. One or more layers on the part can be deposited, and the surface of the part can be activated to prepare it for a subsequent treatment, for example a lacquering or coating. Also coatings of the surface can be hardened by radiation, e.g. ultraviolet, produced by means of plasma. Moreover UV varnishes can be linked. The surfaces can be cauterized or freed from germs. As the surface removals proceed, electrical effects occur on the surface which can be applied to its treatment.

The plasma is produced by the formation of eddy currents on the surface of the part. The alternating current flowing through the part causes oscillating magnetic fields, which spread out depending on the geometry of the part in its environment. The chronological change of the magnetic field proceeds to electric fields which are responsible for the production and maintenance of the plasma in the environment of the part.

According to a successful configuration of the invention, antennae, reflectors, sheet plates, tubes, and/or metal grating are furnished in the vacuum chamber. The part itself represents an antenna, from which electromagnetic waves are radiated into the space of the vacuum chamber. This effect can be supported by additional antenna-like elements in the environment of the part. This includes sheet plates or metal grating. Arranged spiral-shaped tubes, e.g. of copper, can likewise cause this effect. In these parts the electromagnetic waves couple in and cause an additional plasma generation at a certain distance from the part. In this way the radiation flow of the plasma can be directed toward the direction of the part.

According to another successful configuration of the invention, one or more microwave plasma generators are arranged on or in the vacuum chamber. They serve to support a constant partical or energy density at definite points, to ignite the plasma, especially under high pressures or high particle densities in the vacuum chamber, and to precondition or prepare the working substances or their components before or during their introduction into the vacuum chamber.

For example they can be applied to prepare precursor materials. It is advantageous for the position of the microwave plasma generators to be adjustable so they can be optimally adapted to the part. In additon there exists the possibility of arranging the microwave generators outside the vacuum chamber and coupling them via the connector to the vacuum chamber.

Component materials can be converted in the plasma with the method and apparatus depicted in the invention. For this purpose under some conditions an addition source of energy is needed, for example another plasma torch or one of the microwave plasma generators mentioned above. The transformation of materials takes place directly on the surface of the part in the plasma being cauterized there.

By the chronological variation of partical or energy density, gradient layers can be deposited on the surface of the part. By the chronological variation of the materials added to the plasma, several different layers or a series of layers can be deposited on the surface of the part. These can be directed with precision.

According to another successful configuration of the invention a working gas is injected into the vacuum chamber. By doing this, the pressure in the vacuum chamber can be increased.

There are, for example, pressures up to 1000 Pa possible. The working gas alternates chemically with the surface of the part. Different gases can be used as working gases depending on requirements.

According to another successful configuration of the invention, an additional fluid is vaporized and injected by a valve into the vacuum chamber. The steam of the liquid fulfills the same function as the working gas.

According to another successful configuration of the invention an AC-voltage of 0.1 to 10 Mhz is injected into the resonant circuit via the high frequency generator. The AC-voltage especially preferred lies between 1 and 4 Mhz.

According to another successful configuration of the invention the vacuum chamber is evacuated when the pressure is between 0.05 and 1000 Pa. In contrast to the method known from the state of the art, the working pressure can be increased to a few 10 mbar depending on the application. Another device is available to control the number of particles alternating with the surface of the part to be treated.

Other advantages and successful configurations of the invention can be derived from the following descriptions, illustration and claims.

### BRIEF DESCRIPTION OF THE DRAWINGS

In the Figures an example of the apparatus for plasma coating as depicted in the invention is shown. This apparatus is described as follows:

FIG. 1 Apparatus for plasma treatment as seen from the front.

FIG. 2 Apparatus for plasma treatment as seen from above.

FIG. 3 Diagram of the apparatus according to FIGS. 1 and 2.

FIG. 4 Diagram of an apparatus for plasma treatment with two resonant circuits, in which the part has been electrically connected.

FIG. 5 Diagram of another apparatus for plasma treatment with three resonant circuits, where two resonant circuits are furnished with antennae.

FIG. 6 Diagram of an apparatus for plasma treatment according to FIG. 4, which is also furnished with microwave plasma generators.

FIG. 7 Electrical connection between the part and a resonant circuit.

FIG. 8 Integration of a part into a resonant chamber via an electrical connection with an antenna.

FIG. 9 Integration according to FIG. 8 with an additional parallel circuit in the phasing line.

FIG. 10 Integration of a part into two resonant circuits with two high frequency generators.

### DETAILED DESCRIPTION

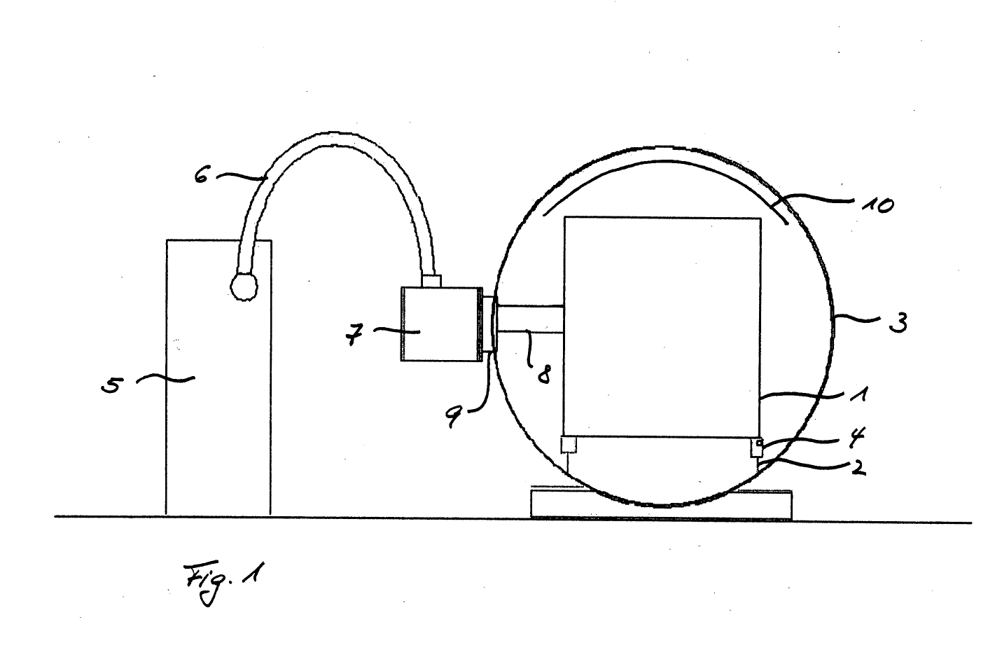

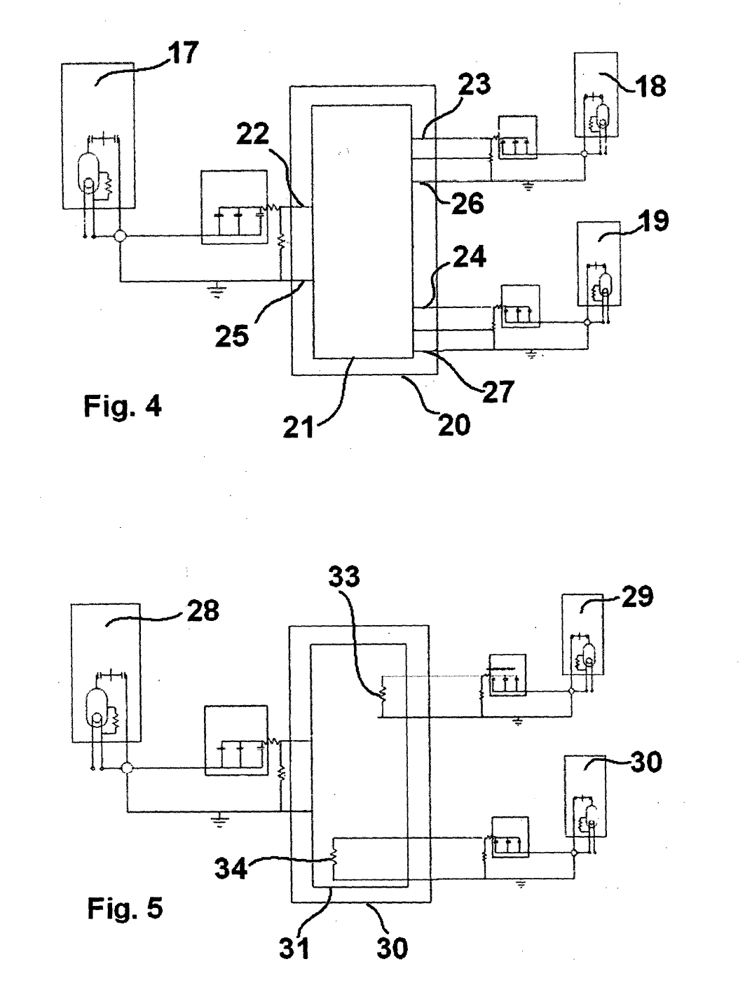

FIGS. 1 to 3 show an apparatus for plasma-supported coating and surface treatment as seen from the front and from above, as well as a relevant diagram. From these figures it can be seen how a part is connected into a first resonant circuit of a first high frequency generator. FIGS. 4 to 6 and 10 show the integration of a part into several resonant circuits.

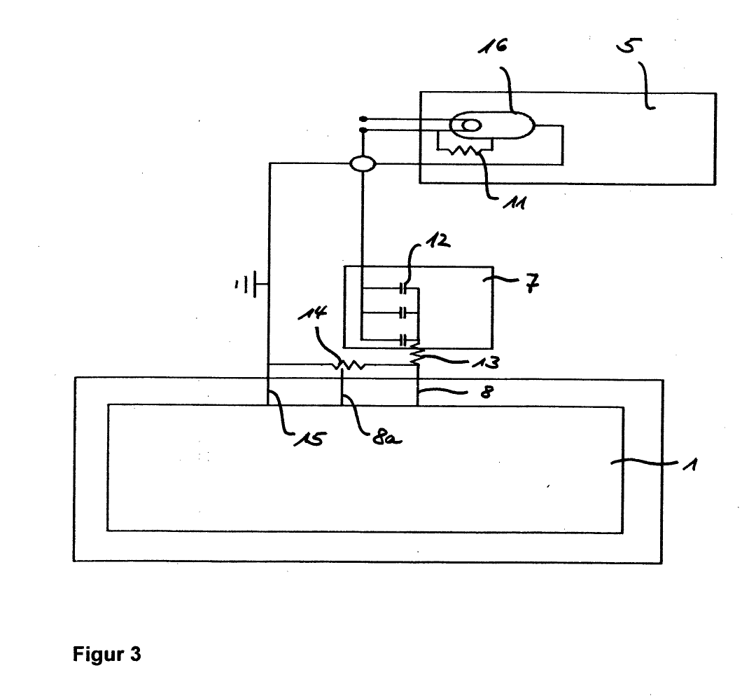

With the apparatus according to FIGS. 1 to 3, a part 1 to be treated is moved via busbars 2 and rollers not visible in the illustration into a vacuum chamber 3. Busbars and rollers together form a transport mechanism. This can be furnished additionally with a drive system which is not depicted in the drawing. An insulation 4 is provided on busbars 2, and this isolates part 1 from vacuum chamber 3. When reaching its end position, the contact is made between a first high frequency resonant circuit and the part. This happens via a sliding contact not visible in the illustration, whose form clings to part 1. The part is now a section of the resonant circuit. The first resonant circuit, other than part 1, consists of a first high frequency generator 5 with a feedback coil 11 represented in FIG. 3, a coaxial cable 6, an outer resonant circuit 7 and a high frequency connector 8, on the end of which the sliding contact is provided. In the vacuum chamber 3 a high frequency access line 9 is provided for high frequency contact 8. Above the part a reflector 10 for the plasma has been provided.

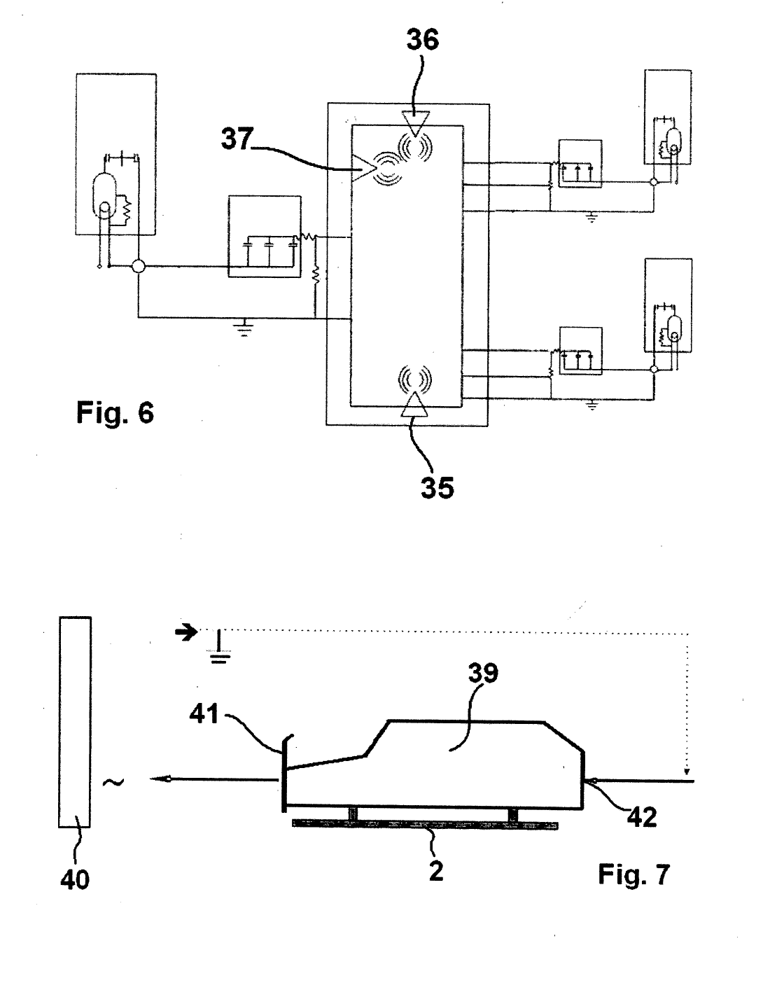

Other resonant circuits and high frequency generators are appropriately or similarly arranged on the vacuum chamber and connected with the part. Diagrams for this are represented in FIGS. 4 and 6.

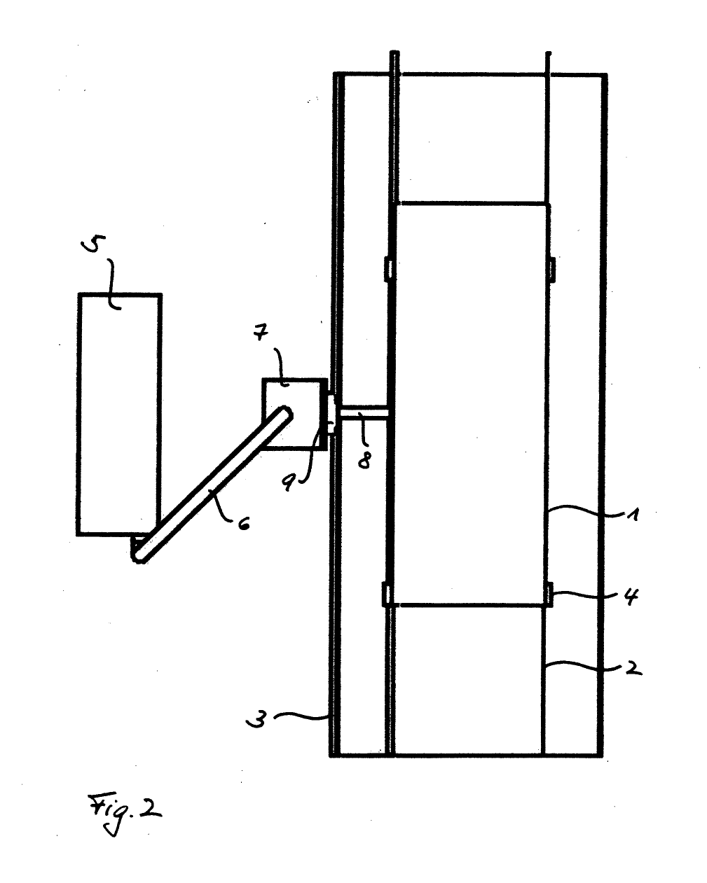

FIG. 3 schematically shows the diagram of the apparatus according to FIGS. 1 and 2. The first high frequency generator 5 supplies the first resonant circuit via coaxial cable 6 with alternating current. The first high frequency generator 5 makes use of a feedback coil 11, which has automatically adjustable inductance. That part of the resonant circuit located outside the vacuum chamber is shown as outer resonant circuit 7. In outer resonant circuit 7, three condensors are provided. Some or all of them can be connected into the resonant circuit, so as to change the total capacitance. The induction of the resonant circuit is essentially determined by part 1. Part 1 is connected with the outer resonant circuit 7 via high frequency connector 8. In order to tune the inductance of the resonant circuit on the part, a coil 13 is provided on the outer resonant circuit. Additionally another coil 14 is provided with a tap on the high frequency connector 8 immediately on coil 13. The latter is connected into the resonant circuit only as needed to adapt to total inductance. In that case high frequency connector 8a is used instead of high frequency connector 8. Part 1 can optionally be grounded via connector 15.

By feeding a high frequency alternating current with very low power, the contact between part 1 and the resonant chamber is tested. If the contact fulfills the requirements, vacuum chamber 3 can be evacuated. After the pressure in vacuum chamber 3 has reached a defined value dependent on the type of treatment, high frequency alternating current is fed into the resonant circuit. On the surface of part 1, plasma is produced which is needed for the treatment of the part.

The control of the influence of the plasma on the surface of the part succeeds by way of the regulation of the anode voltage of transmitting tube 16, which feeds the alternating current into the resonant circuit. By monitoring the voltage response curve of transmitting tube 16 of the resonant circuit, the efficiency of the coupling of the electrical connection to the plasma is controlled. The remote calibration of the resonant circuit during the plasma treatment succeeds by varying the inductance of the feedback coil of the resonant circuit. Previously there also exists the possibility to take a general calibration of the system by attaching additional inductances 14 or capacitances 12 into the resonance circuit on the part to be treated.

FIG. 4 shows the diagram of an example of an apparatus for plasma-supported coating and surface treatment with three resonant circuits and three high frequency generators 17, 18 and 19. Each of the three high frequency generators is connected together with a part 21 arranged in a vacuum chamber 20, each in a resonant circuit. Each high frequency generator and part together form together with the additional capacitances and inductances a first, second and third resonant circuit. Each of the three resonant circuits is furnished with condensors, coils and a transmitting tube corresponding to the diagram in FIG. 3. Thus a detailed description is omitted at this point. The part is electrically connected into all three resonant circuits. For this purpose a connector 22, 23 and 24 of each resonant circuit is linked to the part. A second connector 25, 26 and 27 is grounded.

In contrast to this, another example has three high frequency generators according to FIG. 5 with only a first high frequency generator 28, corresponding to the diagram in FIG. 3 with a part 31, connected in a vacuum chamber 32. Both of the other high frequency generators 29 and 30 are furnished with antennae 33 and 34, so as to emit the energy of the second and third resonant circuit to part 31 and transfer it without contact. Both antennae 33 and 34 are formed as coils. The coupling of part 31 to the second and third resonant circuit is therefore inductive.

The example illustrated in FIG. 6 corresponds to the example according to FIG. 4, but includes three additional microwave plasma generators 35, 36 and 37. The microwave plasma generators are arranged within the vacuum chamber 20.

FIGS. 7 to 10 show different possibilities of coupling the part to a resonant circuit with high frequency generator according to FIG. 3. To simplify things, in FIGS. 7 to 10 merely each high frequency generator, the part and the coupling to the part are depicted, whereas part 39 deals with a vehicle body.

In FIG. 7 part 39 is connected galvanically and thus electrically on two poles to the resonant circuit of a first high frequency generator 40. The part arranged on busbar 2 is connected galvanically with plate 41 serving as a connector while being inserted into a vacuum chamber represented in FIG. 1. The plate enables a form-fitting connection with the part and thus guarantees a sufficient mechanical contact for galvanic intergration. The second pole 42 is connected to mass and has grounding potential.

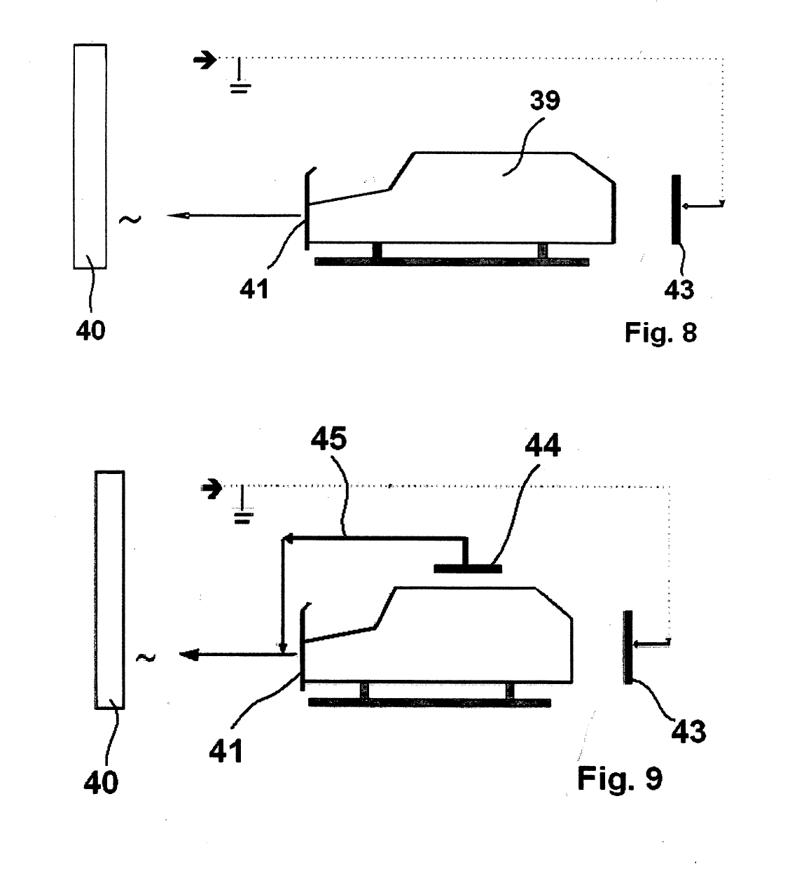

In FIG. 8 part 39, as in FIG. 7, is galvanically coupled at a pole via plate 41 and capacitively on the other pole via a condensor plate 43 into the resonant circuit of the high frequency generator. When being coupled according to FIG. 9 there is for this purpose an additional condensor plate 44 connected with the resonant circuit via phasing line 45 and galvanically coupled to part 39.

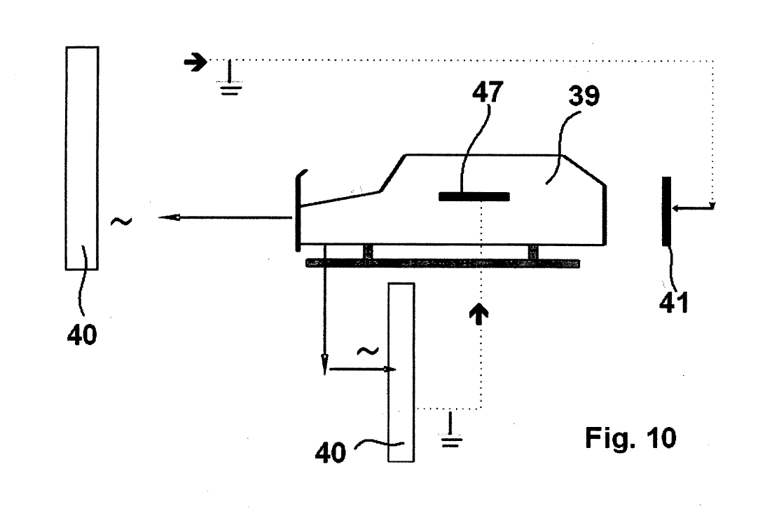

FIG. 10 schematically shows the coupling of part 39 to the first high frequency generator 40 and to the second high frequency generator 40 via a galvanic connector and capacitive connector respectively. The coupling the two resonant circuits of the two high frequency generators 40 succeeds in both cases according to the principle illustrated in FIG. 8. Here the resonant circuit of the second high frequency generator 40 is likewise furnished with a condensor plate 46.

All characteristics of the invention can occur individually or in any combination with each other.

### REFERENCE NUMBERS

1 Part
2 Busbars
3 Vacuum chamber
4 Insulation
5 First high frequency generator
6 Coaxial cable
7 Outer resonant circuit
8 High frequency connection
9 High frequency passage
10 Reflector
11 Feedback coil
12 Condensor of the outer resonant circuit
13 Coil
14 Coil
15 Connection
16 Transmitting tube
17 First high frequency generator
18 Second high frequency generator
19 Third high frequency generator
20 Vacuum chamber
21 Part
22 High frequency connection
23 High frequency connection
24 High frequency connection
25 Second connection
26 Second connection
27 Second connection
28 First high frequency generator
29 Second high frequency generator
30 Third high frequency generator
31 Part
32 Vacuum chamber
33 Antenna
34 Antenna
35 Microwave plasma generator
36 Microwave plasma generator
37 Microwave plasma generator
38
39 Part
40 First high frequency generator
41 Plate
42 Second pole
43 Condensor plate
44 Condensor plate
45 Phasing line
46 Condensor plate

1. Apparatus for plasma-supported coating and surface treatment of voluminous parts, comprising: a vacuum chamber (3, 20, 32) with one or several pumps, a first resonant circuit with a first high frequency generator (5, 17, 28, 40), with an adjustable capacitance and an adjustable inductance of the first resonant circuit, and a first connection for integrating the part the part (1, 21, 32, 39) into the first resonant circuit, with at least a second resonant circuit with a second high frequency generator (18, 29, 40), with a second connector for integrating the part (1, 21, 32, 39) into the second resonant circuit and an adjustable capacitance and an adjustable inductance of the second resonant circuit.

2. Apparatus according to claim 1, characterized in that the second connection for integrating the part (1, 21, 32, 39) into the second resonant circuit is galvanically, capacitively or inductively formed.

3. Apparatus according to claim 1, characterized in that the second resonant circuit is furnished with at least one antenna (33, 34) or one plate (43, 44, 46) in order to transmit the energy of the resonant circuit without contact to the part (1, 21, 32, 39), so that the antenna (33, 34) or the plate (43, 44, 46) is arranged in the vacuum chamber.

4. Apparatus according claim 1, characterized in that the second resonant circuit is furnished with a connector so as to connect galvanically a pole of the part (1, 21, 32, 39) with the second resonant circuit, and that the resonant circuit is furnished with a condensor plate (43, 44, 46) or electrode so as to connect capacitively a second pole of the part (1, 21, 32, 39) with the second resonant circuit.

5. Apparatus according to claim 1, characterized in that it is additionally furnished with at least one microwave plasma generator (35, 36, 37).

6. Apparatus according to claim 5, characterized in that the position of the microwave plasma generator (35, 36, 37) is adjustable relative to the part (1, 21, 32, 39).

7. Method for plasma-supported coating and surface treatment of voluminous parts, comprising the steps of: arranging a part (1, 21, 31, 39) in a vacuum chamber (3, 30, 32) and evacuating the vacuum chamber (3, 20, 32), connecting the part (1, 21, 31, 39) to a first resonant circuit with a first high frequency generator (5, 17, 28, 40), tuning the inductance and/or capacitance of the first resonant circuit to the part (1, 21, 31, 39), and with at least a second resonant circuit and at least a second high frequency generator (18, 19, 29, 30, 40), producing and transmitting additional energy to the part (1, 21, 32, 39).

8. Method according to claim 7, characterized in that the inductance and/or the capacitance of the second resonant circuit is tuned to the part (1, 21, 31, 39).

9. Method according to claim 7, characterized in that part (1, 21, 32, 39) is galvanically connected at least with one pole of the second resonant circuit.

10. Method according to claim 9, characterized in that at least one pole of the second resonant circuit is capacitively or inductively connected with the part (1, 21, 32, 39).

11. Method according to claim 8, characterized in that a coating material is injected into a vacuum chamber (3, 20, 32) and the coating material from the plasma phase is deposited on the part (1, 21, 32, 39).

12. Method according to claim 8, characterized in that the plasma is ignited by at least one additional microwave plasma generator (35, 36, 37).

13. Method according to claim 8, characterized in that the particle density and/or energy density on the surface of the part (1, 21, 32, 39) is held constant spatially and chronologically or varied chronologically by at least one additional microwave generator (35, 36, 37).

14. Method according to claim 8, characterized in that working gases and/or coating materials are prepared or pre-conditioned by at least one microwave plasma generator (35, 36, 37).

15. Apparatus according to claim 2, characterized in that the second resonant circuit is furnished with at least one antenna (33, 34) or one plate (43, 44, 46) in order to transmit the energy of the resonant circuit without contact to the part (1, 21, 32, 39), so that the antenna (33, 34) or the plate (43, 44, 46) is arranged in the vacuum chamber.

16. Apparatus according claim 2, characterized in that the second resonant circuit is furnished with a connector so as to connect galvanically a pole of the part (1, 21, 32, 39) with the second resonant circuit, and that the resonant circuit is furnished with a condensor plate (43, 44, 46) or electrode so as to connect capacitively a second pole of the part (1, 21, 32, 39) with the second resonant circuit.

17. Apparatus according to claim 2, characterized in that it is additionally furnished with at least one microwave plasma generator (35, 36, 37).

18. Method according to claim 8, characterized in that part (1, 21, 32, 39) is galvanically connected at least with one pole of the second resonant circuit.

19. Method according to claim 8, characterized in that at least one pole of the second resonant circuit is capacitively or inductively connected with the part (1, 21, 32, 39).

20. Method according to claim 8, characterized in that a coating material is injected into a vacuum chamber (3, 20, 32) and the coating material from the plasma phase is deposited on the part (1, 21, 32, 39).
